(19) United States
(12) Patent Application Publication
(10) Pub. No.: US 2013/0068129 A1
(43) Pub. Date: Mar. 21, 2013

(54) INFILTRATE-STABILIZED SALT CORES

(71) Applicants: Harald Hudler, Nurnberg (DE); Dieter Käfer, Igensdorf (DE); Josef Baron, Rothenbach (DE); Peter Stingl, Lauf (DE)

(72) Inventors: Harald Hudler, Nurnberg (DE); Dieter Käfer, Igensdorf (DE); Josef Baron, Rothenbach (DE); Peter Stingl, Lauf (DE)

(21) Appl. No.: 13/700,397

(22) PCT Filed: Jun. 1, 2011
(86) PCT No.: PCT/EP2011/059153

§ 371 Date: Nov. 27, 2012

(30) Foreign Application Priority Data
Jun. 2, 2010 (DE) 10 2010 029 656.2

(51) Int. Cl. C08K 3/34

(52) U.S. Cl. CPC C08K 3/34
USPC 106/15.05; 106/600; 106/636; 106/633; 106/632; 106/635; 106/626; 427/372.2; 264/259; 427/294

(57) ABSTRACT

Salt based cores made of a slat, a binder and optionally auxiliary agents are stabilized with an infiltrate.

The invention relates to salt-based cores, methods for producing salt-based cores, and to the use of such cores as a cavity placeholder for the production of metallic castings, preferably using die-casting technology, which cores can be removed from the workpiece by means of a solvent, preferably water, completely and without any problems and without remaining solid residues.

Cores that are inserted into the mold when casting workpieces from metal in order to maintain the cavities that are provided in the workpieces when filling the molds with melt have to meet high requirements. The cores have to be producible in a cost effective manner, have to be dimensionally stable and accurate with regard to the contour, and the materials used for producing them and the solvent dissolving them shall not adversely affect the casting quality or the environment and shall not cause health hazards.

If the surface and the contour accuracy of the cavities of the workpieces have to meet special requirements, the surface of the cores has to be particularly smooth and accurate in terms of the contour, and the cores have to be dissolvable in suitable solvents without any residues and have to be easily removable from the cavities of the workpieces without solid residues remaining therein. Residues of cores can result in damage to the surface to be finished or can cause the failure of an aggregate, for example, if core residues cause clogging of an injection nozzle in the common rail system of a diesel aggregate. Furthermore, rough core buildups negatively influence the surface quality of the casting.

It is an object of the present invention to produce salt-based cores which have as little porosity as possible, have good surface quality and a strength as high as possible, and which, after casting the workpieces, can be easily and completely removed from the workpieces.

Up to now, the prior art has had no success to produce salt-based cores by means of the core shooting method, which cores withstand the extreme mechanical stress that occurs during die-casting, because said cores distort or break or change their position. This means, salt-based cores which, on the one hand, have to have high mechanical strength and, on the other, have to be easily removable from the cast part after casting and which provide for a surface condition in the cast part as good and smooth as possible, have not been produced yet in the prior art by means of the so-called core shooting method for die-casting applications.

This object has been achieved according to the main claim and according to the method according to claim 28. Advantageous configurations of the invention are characterized in the sub claims.

The cores according to the invention consist of salt and can be produced by molding and compressing a core material mixture, wherein the core material mixture contains at least one salt, at least one binder and, if necessary, auxiliary substances such as additives, fillers, wetting agents and catalysts, and the cores are stabilized by an infiltrate. These cores are preferably provided for workpieces which are casted from nonferrous metals, preferably aluminum, using the die-casting method. The cores according to the invention are composed of materials which can be removed from the cavities of the workpiece in a residue-free and easy manner by means of water as the solvent that is preferred for environmental reasons.

The cores according to the invention have the advantage that they are composed of materials (=core materials) which show no or only very little gas-evolving reactions which harm the environment—either during the production of said materials or during the casting process. Due to the fact that during casting no crack products of an organic binder are produced, the quality of the cast parts is improved since casting defects such as blowholes, gas pores or the like caused by occurring core gases can be avoided. After removing the cores from the workpieces, no residues remain which require special disposal.

Molding the cores is carried out through the core shooting method or pressure molding. With these methods, geometrically very complicated shapes can be implemented which cannot be implemented through the conventional dry pressing and sintering concept. Since in the case of the shot cores the strengthening step of sintering is omitted, the binder system has to meet extreme requirements with regard to the stability of the cores. In comparison with low-pressure permanent mold casting, the mechanical and thermal load on the cores during casting is extreme when using die-casting, The incoming flow velocity can be up to 6 m/sec. The hydrostatic pressure can rise to 1200 bar. In general, the cores according to the invention can also be used for other casting methods such as low-pressure permanent mold casting.

Suitable as materials for the cores according to the invention are the salts of the alkali elements and alkaline earth elements such as, in particular, sodium chloride, potassium chloride and magnesium chloride, the sulfates and nitrates of the alkali elements and alkaline earth elements such as, in particular, potassium sulfate, magnesium sulfate, and also ammonium salts such as, in particular, ammonium sulfate, The water soluble representatives of these materials are preferred. Preferred are the water-soluble representatives of these materials. These substances can be used individually or as a mixture provided they do not react with each other and thus negatively influence the desired properties, because during the production of the core, the core material shall not be subjected to a material conversion that negatively influences the residual-free removal of the core material. In general, all readily soluble salts are suited, the decomposition point or melting point of which lies above the temperature of the liquid metal melt. Through the selected grain size distribution and the selected degree of compaction, the surface condition and the mechanical strength of the cores are positively influenced. The smaller the grain size, the smoother the surface. In general, a degree of compaction as high as possible is targeted, which can be achieved by mixing different salts and, if necessary, by admixing additional substances with different distribution curves, for example, through a bimodal or trimodal grain distribution in the mixture, or through suitable fillers.

According to the invention, grain sizes ranging from 0.01 mm to 2 mm are preferred, depending on material, desired surface quality and contour accuracy of the workpiece to be casted. Depending on the desired degree of compaction, different grain size fractions are mixed in different proportions.

Fillers, which likewise can be removed completely and residue-free with water as a solvent, can optionally replace a portion of the salt insofar as density and strength are not negatively influenced by this. According to the invention it has been found that up to 30% by weight of the salt can be replaced by appropriate fillers. The grain size of the filler is advantageously adapted to the grain size or the grain size distribution of the salt.

In order to ensure the required stability of the cores after molding, at least one suitable binder, preferably inorganic binder, or a suitable binder system is added to the salt prior to the compaction. Possible are all binders which, after the curing process, can be removed with water as the solvent without residues and which wet well the salt and optionally the additives, wherein the mixture of these substances has to be Plowable and moldable so as to form lost cores by means of shooting. In general, siliceous binders or mixtures of these binders are suitable if they can be removed in a residue free manner with water as the solvent. Preferably, binders from a sodium silicate having a sodium silicate module of 1 to 5 are used, wherein sodium silicates with a different sodium silicate module can also be present as a mixture. The added amount depends on the sodium silicate module used and ranges, depending on the wetting behavior, between 0.5% by weight and 20% by weight, preferably between 5% by weight and 10% by weight. In order to achieve the properties such as strength and dimensional stability required for the subsequent casting process, it is also possible to use special mixtures of binders.

The properties of the inventive mixture of salt and binder or binder system can be influenced by systematically adding additives. Here too, the requirement is that these additives or the reaction products of these additives can be easily removed from the cavity of a workpiece, completely and without residues, with water as the solvent, and that during casting no gases are released which negatively influence the casting process and can cause casting defects. Depending on the composition of the core materials, these additives can be selected from: wetting agents, for example surfactants, additives influencing the consistency of the mixture, antiblocking agents, deagglomeration additives, gelling agents, additives which change the thermophysical properties of the core, for example, the thermal conductivity, additives which prevent metals from adhering to the cores, additives which result in a better homogenization and miscibility, additives which increase the shelf life, additives which prevent premature curing, and additives which result in acceleration of the curing. These additives are known to the person skilled in the art from the production of conventional cores. The amount of these additives to be added depends on the type and the composition of the core material.

In order that the cores have the required strength after molding, it can be necessary, depending on the composition of the core material, to use catalysts adapted thereto which initiate and accelerate the curing.

If, according to the invention, gaseous catalysts are used, the gas influencing the core material, preferably CO₂ or air, in particular for curing and drying the cores, can be blown after the shooting into the still closed mold. The pressure can be up to 5 bar.

Also possible is a thermal aftertreatment of the cores at temperatures up to 700° C.

The core material is composed of the salt, the binder and, if required, the auxiliary substances such as fillers, additives and catalysts, wherein the fillers and the binder are inorganic. All substances can be homogenously mixed with known mixing aggregates. The amount to be added of binder and auxiliary materials is to be selected based on the intended use of the cores and determines the surface quality as well as the density and strength of the cores.

For further processing of the core material into the usable core, it is of fundamental importance in which form the core material is present.

If, as in the present invention, solid core materials are preferred, it is of decisive importance if the core materials are agglomerated or deagglomerated, or if they are present in flowable form. This flowability of the mixture is useful during the shooting process for filling the mold evenly and with the best possible compaction, Thus, according to the invention, flowable mixtures of the salt, the sodium silicate used as a binder and the other admixtures are particularly preferred as a core material.

Specifically during die-casting, the cores are subjected to extreme thermal and mechanical stress which in the case of conventional cores can result in breakage or in a more or less distinctive offset of the cores in the cast part.

Therefore, according to the invention, infiltration of the shot core with an infiltrate is provided for improving the stability of the cores.

Only through the inventive stiffening and strengthening of the cores by means of a suitable infiltration of the cores, it has surprisingly been achieved to implement dimensionally accurate die-casting parts with salt cores. In addition, the infiltration can significantly improve the surface quality of the cores.

An infiltrate that is suitable according to the invention contains at least one finely-ground material that is selected from at least one of the following finely-ground substances diatomites, calcined kaolins, zirconium oxide, zirconium silicate (zirconium powder, zirconium sand), aluminum oxide, andalusite, fireclay, iron oxide, cyanite, bauxite, olivine, quartzes, graphites and soots. Preferred according to the invention is finely-ground material that has no platelet structure; particularly preferred is zirconium silicate (zirconium powder) or zirconium oxide, more preferred is zirconium silicate (zirconium powder) or zirconium oxide with D₅₀<1 μm.

In order to be able to infiltrate the core with infiltrate, the at least one selected finely-ground material is dispersed in a suitable infiltrate medium (hereinafter also referred to as liquid component or solvent component).

It has surprisingly been found that the cores to be stabilized in this manner, although these cores consist of readily soluble components, and that even cores consisting of water-soluble components can be infiltrated and stabilized by the infiltrate according to the invention with the method according to the invention without losing their shape.

The infiltrate medium of the infiltrate according to the invention is selected from water or at least one volatile, preferably aliphatic alcohol or a mixture of alcohols with, if necessary, further components, for example, at least one organic volatile solvent that differs from said alcohols, or is selected from mixtures of these solvent components. The infiltrate medium preferred according to the invention is water.

In a preferred embodiment, the water-based infiltrate suspension according to the invention (in connection with this invention also referred to as infiltrate dispersion) comprises—based on all constituents of the infiltrate suspension—10-50% by weight of solvent, 50-90%, by weight of finely-ground material, optionally dispersing agents, binders and further additives such as, for example, further particle-shaped materials, wetting agents, defoamers, dyes and/or pigments and/or biocides.

As binders usable according to the invention for the filtrate suspension, for example, starch, dextrin, lignin sulfate, peptides, polyvinyl alcohol, polyvinyl acetate copolymers, polyacrylic acid, polystyrene dispersion, polyvinyl acetate dispersions, polyacrylate dispersions and mixtures thereof can be used. In a preferred embodiment of the invention, the binder is water-soluble. The binders are used in a quantity of 0-20% by weight, preferably in a quantity of 5-10% by weight based on the total of the water-based infiltrate.

As wetting agents, preferably, anionic and non-anionic surfactants of medium and high polarity (HSB value of 7 and higher), which are known to the person skilled in the art, can be used. The wetting agents are used in a quantity of 0-5% by weight, preferably in a quantity of 0.01-1% by weight, particularly preferred in a quantity of 0.05-0.3% by weight based on the total of the infiltrate components.

Defoamers are used in the present invention in a quantity of 0-1% by weight, preferably in a quantity of 0.01-1% by weight, particularly preferred in a quantity of 0.05%-0.3% by weight,

In the infiltrate dispersion according to the invention, commonly used pigments and dyes can be used, if necessary. They can be added in order to be able to track the penetration depth of the infiltrate in the core or to make a contrast visible, e.g., between different layers. The dyes and pigments are usually used in a quantity of 0-10% by weight, preferably in a quantity of 0.01-10% by weight, particularly preferred in a quantity of 0.1-5% by weight.

If necessary, commonly used dispersing agents can be added to the infiltrate dispersion according to the invention. The dispersing agents are used in a quantity of 0-3% by weight, preferably in a quantity of 0.01-1.5% by weight, particularly preferred in a quantity of 0.02-0.5% by weight.

In a preferred embodiment, an infiltrate dispersion according to the invention contains in addition to the finely-ground material the following components:
0.02-0.5% by weight of dispersing agent,
0.5-3.0% by weight of binder,
0.01-0.5% by weight of wetting agent,
0.01-0.5% by weight of defoamer,
0-5.0% by eight of pigments,
0-5.0% by weight of dyes,

As an infiltrate medium, preferably, water is used.

The infiltrate dispersions according to the invention are produced according to usual methods, for example, in that a large portion of the total quantity of the liquid component (solvent component), preferably the entire infiltrate medium, is provided and the finely-ground material is solubilized therein using a high-shearing stirrer (e.g. 400-2000 rpm), Subsequently, if necessary, the further components are admixed individually or as a mixture until a homogenous mixture is created. The order of the addition plays no role or only a minor role. The infiltrate dispersion according to the invention is produced at a temperature of preferably 5-50° C.

The infiltrate dispersions according to the invention can be used for stabilizing casting cores, preferably for stabilizing shot salt cores according to the present description. In general, the infiltration method according to the invention can also be used for sand cores. The term “salt core” used here comprises all types of bodies that can be used for producing a cast part such as, for example, cores, molds and dies. Also, it is possible to bring the salt cores only partially into contact with the infiltrate dispersions according to the invention. Preferably, those portions of the salt core that come into contact with the casting metal are stabilized. The infiltrate dispersions according to the invention are suitable for all conceivable applications in which stabilization of salt cores is desired,

For this purpose, the shot salt core is exposed after molding to the infiltrate, for example by dipping the core into an infiltrate dispersion according to the invention, Alternatively, infiltrating can also be carried out by means of a vacuum. If only portions of the core shall be stabilized by the infiltrate, only the core portions to be stabilized are brought into contact with the infiltrate dispersion. The contact time of the core with the infiltrate dispersion is based on the desired penetration depth of the infiltrate into the core, wherein a penetration depth ranging between 2 mm and preferably complete infiltration has been found to be particularly suitable.

Salt cores, preferably salt cores according to the above description have been infiltrated with the infiltrate dispersion according to the invention by dipping,

When dipping, the salt core to be stabilized, optionally only the area to be stabilized, remains dipped in a container with a ready-to-use inventive infiltrate dispersion as long as required for the degree of stabilization to be achieved, which degree has been determined in preliminary tests. It has been found that, as a general rule, dipping times of from 0.1 seconds to several minutes, preferably of from 10 seconds to 20 seconds, result in the desired degree of stabilization. After infiltration, the infiltrated core is dried in a suitable manner.

In particular when using the cores for the die-casting method, it has been found that completely infiltrated cores achieve the best results with regard to the exact position of the core in the cast part. The reason for this is the compressibility of the cores when the cores are pressurized by the metal melt, which compressibility is significantly reduced by the infiltration.

For improving the surface quality of the cavities generated by the salt cores in the cast part, the infiltrated cores can additionally be provided with a facing (salt facing, graphite facing or other commercially available facings).

The composition and the properties of a core have a substantial influence on the quality of the cast part.

The infiltrated sodium-chloride-based salt cores produced according to the invention usually have a density of from 1.2 g/cm³ to 2.5 g/cm³, preferably of from 1.6 g/cm³ to 2.0 g/cm³. The flexural strength, measured according to VDG-Merkblatt P73 ranges between 400 N/cm² and 2000 N/cm².

The most important properties are outlined below by means of an exemplary embodiment. The mentioned properties relate to cores that are not covered with a facing.

Used is a core from NaCl according to the present invention comprising the following additional substances such as sodium silicate binder and further additives such as releasing agents, setting retarders, wetting agents and the like. The core according to the invention was molded on a conventional core shooter at a pressure of up to 15 bar. This core according to the invention is particularly suitable for use in aluminum die-casting; however, it can also be used for other casting methods (e.g. low-pressure permanent mold casting). In order to be able to resist the temperatures and forces occurring during casting, the core has to be dimensionally stable.

When the metal melt flows in, the surface of the core must not be washed out or damaged. For this reason, the core according to the invention has an appropriate surface strength.

After the cast part has completely solidified, the core according to the invention is removed. It is important here that the core completely and easily dissolves immediately and without residues. (Note: if “water-soluble”, “solubilize” or “dissolve” is mentioned within the context of the present invention, this does not necessarily refer to the chemical term of dissolving. It is crucial here that the constituents of the cores according to the invention can easily, completely and without residues be removed from the cavity of the cast part with water as the solvent. The dissolution rate of the core material naturally depends on the core material and its pre-treatment and also on the core size and the geometry (shape). Tests with a test part have shown that a core according to the invention with the dimensions 22 mm×22 mm×180 mm can be completely and without residues washed out with hot water from the cast part within 0.05 min to 1 min.

The present invention therefore relates to salt-based cores that can be produced by molding and compacting a core material mixture, wherein this core material mixture contains at least one salt, at least one binder and, if necessary, auxiliary substances such as additives, fillers, wetting agents and catalysts, and the cores are stabilized by an infiltrate.

In the case of the respective cores it is preferred according to the invention:
that the salt, the binder and the optionally used auxiliary substances are inorganic, these core materials are dissolvable with water as the solvent, and the cores are molded by means of the core shooting method;
that the salt, the binder and the optionally used auxiliary substances are inorganic, these core materials are dissolvable with water as the solvent, and the cores are molded by means of pressing;
that the core material mixture is flowable;
that core material mixture is pourable;
that salts are used, the decomposition point or melting point of which lies above the temperature of the liquid metal that is casted around the core;
that as salts, chlorides of the alkali elements and alkaline earth elements, in particular, sodium chloride, potassium chloride and/or magnesium chloride, sulfates and nitrates of the alkali elements and alkaline earth elements, in particular, potassium sulfate and/or magnesium sulfate, ammonium salts, in particular, ammonium sulfate or mixtures of these salts are used;
that said salt is sodium chloride;
that the grain sizes of the salt used range of from 0.01 mm to 2 mm;
that the salt used is present in bi- tri- or multi-modal grain size distribution;
that the salt used is present in a grain size distribution of from 0.01 to 0.29 mm, 0.3 to 1.3 mm and/or 1.31 to 2.0 mm;
that water-soluble silicate compounds, preferably sodium silicates, are used as binders;
that the binder is a sodium silicate with a sodium silicate module of 1 to 5 and/or a mixture of sodium silicates with different sodium silicate modules;
that the proportion of binders is between 0.5% by weight and 15% by weight;
that the proportion of the binder lies between 0.5% by weight and 15% by weight in dependence on the wetting behavior and the sodium silicate module;
that sodium silicate is contained as a binder in a proportion of 0.5% by weight to 15% by weight in dependence on the grain size distribution and adapted to the sodium silicate module;
that a catalyst is added as an auxiliary substance;
that the salt is sodium chloride that is preferably present in bi- or tri-modal grain size distribution, particularly preferred in a grain size distribution of 0.01 to 0.29 mm, 0.3 to 1.3 mm and/or 1.31 to 2.0 mm, the binder is sodium silicate, the catalyst is particularly fine-grained salt, preferably powdery salt, that, if necessary, further auxiliary substances are contained such as additives, fillers, wetting agents and/or further catalysts, and that the mixture of the core materials is pourable;
that cores are heat-treated after molding;
that the cores are heat-treated after molding at a temperature of 700° C.;
that the molded cores have a density of from 1.5 g/cm³ to 1.9 g/cm³, preferably of from 1.2 g/cm³ to 1.8 g/cm³;
that they have a porosity of from 10% to 40%, preferably of from 5% to 25%;
that they have a flexural strength between 400 N/cm² and 3000 N/cm²;
that the cores are infiltrated with a suspension (infiltrate) for the purpose of reinforcing/stiffening;
that the infiltrate contains at least one finely-ground material that is selected from at least one of the following finely-grained basic materials: diatomites, calcined kaolins, metakaolinite, zirconium oxide, zirconium silicate (zirconium powder, zirconium sand), aluminum oxide, andalusite, fireclay, iron oxides, cyanite, bauxite, olivine, quartzes, talc, graphites and soots as well as clays and minerals containing said basic materials;
that the infiltrate contains at least one finely-ground material that has no platelet structure;
that the infiltrate contains zirconium silicate (zirconium powder) or zirconium oxide, particularly preferred zirconium silicate (zirconium powder) or zirconium oxide with D₅₀<1 μm;
that the infiltrate contains in addition, if necessary, dispersing agents, binders and further additives such as, for example, particle-shaped materials, wetting agents, defoamers, dyes and/or pigments and/or biocides.

The teaching according to the invention further relates to a method for producing salt-based cores, wherein
at least one salt, at least one binder and, if necessary, additional auxiliary substances such as additives, fillers, wetting agents and catalysts in non-liquid form are homogenously mixed and are molded to form a core and are compacted, and the compacted core is infiltrated with an infiltrate that is suspended/dispersed in a suitable infiltrate medium, and is subsequently dried,

Preferred according to the invention is a method wherein
the core is compacted using the core shooting method;
the core is produced by dry pressing;
salt having grain sizes with different distribution curves is preferably used and mixed in a bi-, tri- or multi-modal grain distribution;
that as salts, chlorides of the alkali elements and alkaline earth elements, in particular, sodium chloride, potassium chloride and/or magnesium chloride, sulfates and nitrates of the alkali elements and alkaline earth elements, in particular, potassium sulfate and/or magnesium sulfate, and also ammonium salts, in particular, ammonium sulfate or mixtures of these salts are selected, which, if necessary, are homogenously mixed with the additional auxiliary substances and are molded into a core and compacted by means of the core shooting method or by pressure molding;
the core materials, depending on material, desired surface quality and contour accuracy of the workpiece to be casted from metal, are used with grain sizes in the range of from 0.01 mm to 2 mm, are molded into a core, and are molded and compacted using the core shooting method or the pressing method;
the infiltrate contains at least one finely-ground material selected from at least one of the following finely-grained basic materials: diatomites, calcined kaolins, metakaolinite, zirconium oxide, zirconium silicate (zirconium powder, zirconium sand), aluminum oxide, andalusite, fireclay, iron oxides, cyanite, bauxite, olivine, quartzes, talc, graphites and soots as well as clays and minerals containing said basic materials;
the infiltrate consists of water, of one or a plurality of volatile, preferably aliphatic, alcohols or a mixture of alcohols with, if necessary, further components, for example, one or a plurality of organic volatile solvents that differ from the alcohols, or consists of mixtures of these solvent components;
infiltrating the cores is carried out by dipping the cores into the infiltrate suspension;
infiltrating the cores is carried out by sucking in the infiltrate suspension by means of a vacuum;
the infiltration is carried out up to a depth of 1 mm and preferably to complete infiltration;
the shot or pressed salt cores are additionally subjected to a sintering treatment prior to infiltrating;
the shot or pressed cores are infiltrated and are subsequently subjected to an additional sintering treatment;
the cores are additionally provided with a facing.

The teaching according to the invention further relates to the use of the cores according to the invention
as cavity placeholders when producing metallic cast parts by metal casting, preferably using die-casting technology;
as cavity placeholders when producing cast parts using permanent mold casting or gravity casting;
as cavity placeholders when producing plastic parts using injection molding technology.

1-44. (canceled)

44. Salt-based cores comprising:
an infiltrate; and
a cores material mixture containing at least one salt and at least one binder, wherein said cores are stabilized by said infiltrate.

45. The salt based cores according to claim 44, wherein the cores material mixture further comprises an auxiliary substance.

46. The salt based cores according to claim 45, wherein the auxiliary substance is selected from the group consisting of an additive, a filler, a wetting agent and a catalyst. s, and that the cores are stabilized by an infiltrate.

47. The salt-based cores according to claim 44, wherein the salt and the binder are inorganic.

48. The salt based cores according to claim 47, wherein the salt and the binder are water soluble.

49. The salt-based cores according to claim 44, wherein the cores material mixture is flowable.

50. The salt-based cores according to claim 44, wherein the cores material mixture is pourable.

51. The salt-based cores according to claim 44, wherein the salt has a decomposition point or melting point which lies above the temperature of a liquid metal cast around the cores.

52. The salt-based cores according to claim 44, wherein the salt is selected from the group consisting of an alkali chloride, an alkaline earth chloride, an alkali sulfate, an alkaline earth sulfate, an alkali nitrate, an alkaline earth nitrate and an ammonium salt.

53. The salt-based cores according to claim 44, wherein the salt is sodium chloride.

54. The salt-based cores according to claim 44, wherein the salt has a grain size in the range of from 0.01 mm to 2 mm.

55. The salt-based cores according to claim 44, wherein the salt is present in bi-, tri-, or multimodal grain size distribution.

56. The salt-based cores according to claim 44, wherein the salt is present in a grain size distribution of from 0.01 to 0.29 mm, from 0.3 to 1.3 mm or from 1.31 to 2.0 mm.

57. The salt-based cores according to claim 44, wherein the binder is a water-soluble silicate compound.

58. The salt-based cores according to claim 44, wherein the binder is a sodium silicate with a sodium silicate module of 1 to 5.

59. The salt-based cores according to claim 44, wherein the proportion of the binder is between 0.5% by weight and 15% by weight in dependence on the wetting behavior and the sodium silicate module.

60. The salt-based cores according to claim 44, wherein sodium silicate is contained in a proportion of 0.5% by weight to 15% by weight in dependence on the grain size distribution and adapted to the sodium silicate module.

61. The salt-based cores according to claim 45, wherein the auxiliary substance is a catalyst.

62. The salt-based cores according to claim 61, wherein the salt is sodium chloride, the binder is sodium silicate, and the catalyst is a fine-grained salt.

63. The salt-based cores according to claim 44, wherein the cores are heat-treated after molding.

64. The salt-based cores according to claim 44, wherein the cores are heat-treated after molding at a temperature of 700° C.

65. The salt-based cores according to claim 44, wherein the molded cores have a density of from 1.5 g/cm³ to 1.9 g/cm³.

66. The salt-based cores according to claim 44, wherein said cores have a porosity of from 1% to 40%, preferably of from 5% to 25%.

67. The salt-based cores according to claim 44, wherein said cores have a flexural strength between 400 N/cm² and 3000 N/cm².

68. The salt-based cores according to claim 44, wherein the cores are infiltrated with a suspension (infiltrate) for the purpose of reinforcing/stiffening.

69. The salt-based cores according to claim 44, wherein the infiltrate comprises at least one finely-ground material selected from the group consisting of: a diatomite, a calcined kaolin, metakaolinite, zirconium oxide, zirconium silicate, aluminum oxide, andalusite, fireclay, an iron oxide, cyanite, bauxite, olivine, a quartz, talc, a graphite, a soot, a clay and a mineral.

70. The salt-based cores according to claim 69, wherein the infiltrate comprises a finely-grained material that has no platelet structure.

71. The salt-based cores according to claim 44, wherein the infiltrate comprises at least one zirconium compound selected from the group consisting of zirconium silicate and zirconium oxide.

72. The salt-based cores according to claim 44, wherein the infiltrate contains at least one member selected from the group consisting of a dispersing agent, an infiltrate binder and a further additive.

73. A method for producing salt-based cores, comprising the steps of homogenously mixing a salt and a binder in non-liquid form to form a homogeneous mix;
molding the homogeneous mix into cores and compacting them to form compacted cores;
infiltrating the compacted cores with an infiltrate that is dispersed in an infiltrate medium to form infiltrated cores; and
subsequently drying the infiltrated cores to yield the salt-based cores.

74. The method according to claim 73, wherein the cores are compacted using the cores shooting method.

75. The method according to claim 73, wherein the cores are produced by dry pressing.

76. The method according to claim 73, wherein the salt has grain sizes having different distribution curves.

77. The method according to claim 73, wherein the salt is wherein the salt is selected from the group consisting of an alkali chloride, an alkaline earth chloride, an alkali sulfate, an alkaline earth sulfate, an alkali nitrate, an alkaline earth nitrate and an ammonium salt.

78. The method according to claim 73, wherein the salt-based core material has a grain size in the range of from 0.01 mm to 2 mm.

79. The method according to claim 73, wherein the infiltrate comprises at least one finely-ground material selected from the group consisting of: a diatomite, a calcined trietakaofinite, zirconium oxide, zirconium silicate, aluminum oxide, andalusite, fireclay, an iron oxide, cyanite, bauxite, olivine, a quartz, talc, a graphite, a soot, a clay and a mineral.

80. The method according to claim 73, wherein the infiltrate medium consists of water, an alcohol, or an volatile solvent that differs from the alcohol.

81. The method according to claim 73, wherein infiltrating the cores are carried out by dipping the cores into the infiltrate suspension.

82. The method according to claim 73, wherein infiltrating the cores are carried out by sucking in the infiltrate suspension by means of a vacuum.

83. The method according to claim 73, wherein the infiltration is carried out up to a depth of 1 mm.

84. The method according to claim 73, wherein the shot or pressed salt-based cores are additionally subjected to a sintering treatment prior to infiltrating.

85. The method according to claim 73, wherein the shot or pressed cores are infiltrated and are subsequently subjected to a sintering treatment.

86. The method according to claim 73, wherein the salt-based cores are provided with a facing.

87. A metal cast part comprising metal and the salt-based cores according to claim 44.

88. The method of claim 73, wherein the casting is in a permanent mold r a gravity casting mold.

89. A method comprising the steps of:
Placing the salt-based cores according to claim 44 into an injection mold; and
injecting a plastic the mold.

90. The salt-based cores of claim 52, wherein the salt is selected from the group consisting of sodium chloride, potassium chloride, magnesium chloride, potassium sulfate, magnesium sulfate, and ammonium sulfate.

91. The salt-based cores according to claim 71, wherein the zirconium compound has a D₅₀<1 μm.

92. The salt-based cores according to claim 72, wherein the infiltrate further comprises a member selected from the group consisting of a further particle-shaped material, wetting agents, a defoamer, a dye and/or pigments or biocides.
